(19) United States
(12) Patent Application Publication
(10) Pub. No.: US 2019/0030877 A1
(43) Pub. Date: Jan. 31, 2019

(54) IMPROVED STEREOLITHOGRAPHY MACHINE WITH FACILITATED INITIALIZATION

(71) Applicant: DWS S.R.L., THIENE (VI) (IT)

(72) Inventor: Carlo Antonio MOSCHELLA, Thiene (VI) (IT)

(73) Assignee: DWS S.R.L., THIENE (VI) (IT)

(21) Appl. No.: 16/071,055

(22) PCT Filed: Jan. 13, 2017
(86) PCT No.: PCT/IB2017/050186

§ 371 Date: Jul. 18, 2018

(30) Foreign Application Priority Data
Jan. 15, 2016 (IT) 1020160000034931

(51) Int. Cl. B33Y 40/00; B33Y 30/00; B33Y 10/00

(52) U.S. Cl. CPC B33Y 40/00; B33Y 10/00; B33Y 30/00

(57) ABSTRACT

The invention is a stereolithography machine (1) comprising: a tank (2) with a bottom (2a); a supporting unit (5) associated with moving means (4) suited to move it according to a direction of movement (Z) which is orthogonal to the bottom (2a); a modelling plate (3) having a modelling surface (3a) facing the bottom (2a) in order to support a three-dimensional object; a coupling unit (6) suited to removably connect the modelling plate (3) to the supporting unit (5) and comprising a housing (7) and a spherical body (8) revolvingly arranged in the housing (7); releasable clamping means (9) suited to be operated in such a way as to press the housing (7) and the spherical body (8) against each other so as to make them integral with each other and to make the modelling plate (3) integral with the supporting unit (5).

The present invention concerns a stereolithography machine whose initialization is particularly simple and which, therefore, is suited to be used also by inexpert operators.

As is known, a stereolithography machine is used for the production of complex three-dimensional objects, starting from a light-sensitive resin which is polymerized in layers by means of a light beam.

A stereolithography machine comprises a tank containing the above mentioned resin and a modelling plate which faces the bottom of the tank and supports the three-dimensional object being formed.

The modelling plate is associated with a supporting unit so that it can be moved according to a direction of movement that is orthogonal to the bottom of the tank.

In order to make each layer of the object, the surface of the preceding layer or, in the case of the first layer, the surface of the modelling plate are immersed in the resin until they are arranged at a distance from the bottom of the tank which is equal to the thickness of the layer to be obtained, in such a way as to define a corresponding layer of resin.

Successively, said resin layer is polymerized through irradiation with a light beam coming from under the tank, which for this purpose has a transparent bottom.

Before the processing cycle can be started, the machine needs to be initialized with a procedure during which the modelling plate is regulated with respect to the supporting unit so that its surface is as parallel to the bottom of the tank as possible.

Said initialization procedure, furthermore, allows the machine to store the actual position of the bottom of the tank, so that said surface can be placed automatically and precisely at any prefixed distance from the bottom itself.

Said initialization procedure is necessary because the dimensions of the tank, which is usually made of a plastic material, are not known in advance and show tolerances in terms of both size and shape.

In fact, the incorrect positioning of the modelling plate with respect to the bottom of the tank can damage the tank itself, in addition to causing the faulty solidification of the first layers of the object, which in turn may lead to the production of processing rejects.

Therefore, the initialization procedure must be carried out when the machine is used for the first time and after each replacement of the tank.

Since the thickness of each layer of the object is generally of the order of tenths of millimetres, very high precision is required when positioning the plate with respect to the bottom of the tank.

According to the initialization procedure known in the art, the modelling plate is brought into contact with the bottom of the tank while at the same time keeping it released from the supporting unit, in such a way as to allow it to be positioned in close contact with the bottom of the tank.

For this purpose, the modelling plate is associated with the supporting unit is through movable means that allow both its relative movement with respect to the supporting unit according to the direction of movement and its limited rotation according to axes that are orthogonal to the direction of movement. After placing the modelling plate in contact with the bottom of the tank, the operator acts on special adjustable spacers that project from the supporting unit towards the modelling plate, extending them until they come into contact with the modelling plate itself.

Finally, the operator acts on a screw which, exerting a traction force on the modelling plate, locks it against said spacers.

The position obtained in this manner is stored by the control system of the supporting unit.

The initialization procedure just described above poses the drawback that it is rather complex and, therefore, not suited to be carried out by an inexpert operator.

Said procedure poses the further drawback that, if the forces applied to the different spacers are excessive or different from one another, they generate non-negligible and/or non-homogeneous deformations on the bottom of the tank, which lead to considerable imprecision in the positioning of the modelling plate itself.

According to the known art, in order to avoid the drawback described above a paper sheet is interposed between the modelling plate and the bottom of the tank. After placing the modelling plate in contact with the bottom of the tank and tightening the spacers, the operator makes sure that the paper sheet can still be removed from under the modelling plate, which ensures the absence of excessive localized pressures.

It can be understood that said operation makes the initialization procedure even more complex and furthermore is characterized by scarce repeatability, thus introducing possible errors.

As a further drawback, the interposition of the paper sheet prevents the modelling plate from resting perfectly on the bottom of the tank, due to the thickness of the paper sheet itself.

Since generally said thickness is not known with sufficient precision, there is the further drawback that a certain degree of approximation is introduced in the initialization procedure, further limiting the precision obtained.

In addition to the above, the interposition of said sheet poses the drawback that the initialization procedure cannot be carried out with the tank filled with resin.

According to a known embodiment of a stereolithography machine, in the attempt to at least partially overcome the drawbacks described above, the tank is supported by elastic elements that allow a certain excursion of the same in the direction of movement of the modelling plate.

Said excursion eliminates the need for the initialization procedure, since the yielding of the elastic elements makes it possible to compensate for the imprecise dimensions of the tank.

However, since said dimensional imprecision is not known in advance, during the production of the first layers of the three-dimensional object the modelling plate will come to be arranged in an incorrect position with respect to the bottom of the tank, thus leading to a faulty configuration of the layers themselves.

Consequently, in the embodiment described above, it is necessary to provide for some “disposable” initial layers, which will be successively eliminated at the end of the processing cycle.

In order to correctly eliminate said initial layers it will be necessary to interpose some easily separable elements, which will occupy further layers, between the layers themselves and the object.

Obviously, the creation of said disposable layers and of the further layers increases the overall processing time and the quantity of resin necessary for the construction of the object. Further embodiments of stereolithography machines that allow the position of the modelling plate to be regulated with respect to the supporting unit are described in documents WO 2013/177620 and US 2015/0328841.

The present invention intends to overcome all of the above mentioned drawbacks which are typical of the stereolithography machines of the known types described above.

In particular, it is an object of the present invention to provide a stereolithography machine that can be initialized by means of a simpler procedure compared to that described above.

It is another object of the present invention to provide a machine that allows a more precise initialization procedure to be carried out, without making the same procedure more complicated.

The objects described above are achieved by a stereolithography machine made according to the main claim. Further characteristics and details are specified in the corresponding dependent claims.

Advantageously, the easier initialization of the machine that is the subject of the invention makes the latter suited to be used also by inexpert operators. Still advantageously, the easier initialization of the machine that is the subject of the invention makes it possible to carry out the initialization procedure more rapidly compared to the machines of the known type, thus reducing machine downtimes.

Still advantageously, the higher initialization precision which can be achieved with the machine that is the subject of the invention avoids the need to provide additional initial layers for the three-dimensional object, thus reducing the time necessary to make the object itself and the quantity of resin required.

Said objects and advantages, together with others that will be mentioned later on, are illustrated in the description of a preferred embodiment of the invention which is provided by way of non-limiting example with reference to the attached drawings, wherein:

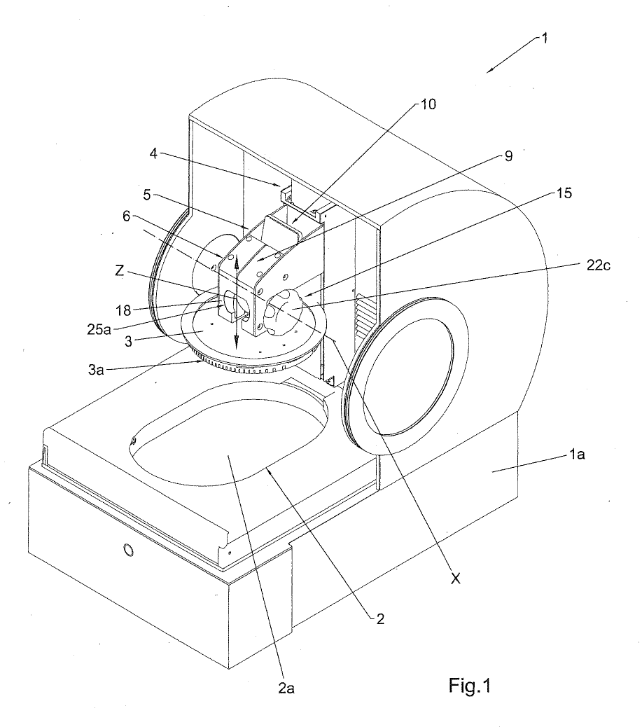

FIG. 1 shows an axonometric view of the stereolithography machine of the invention;

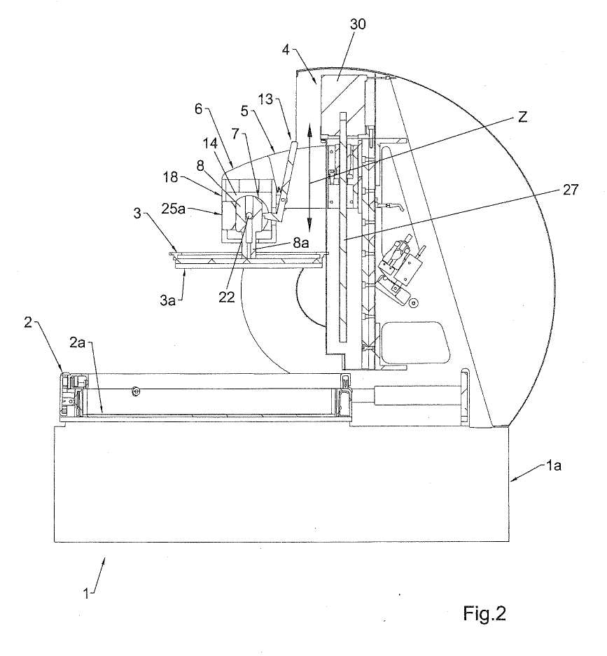

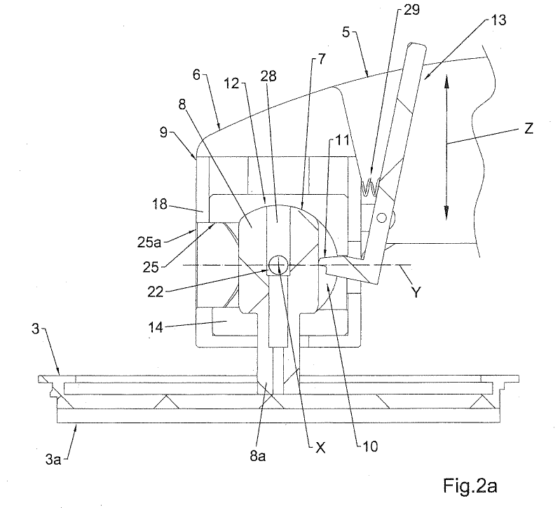

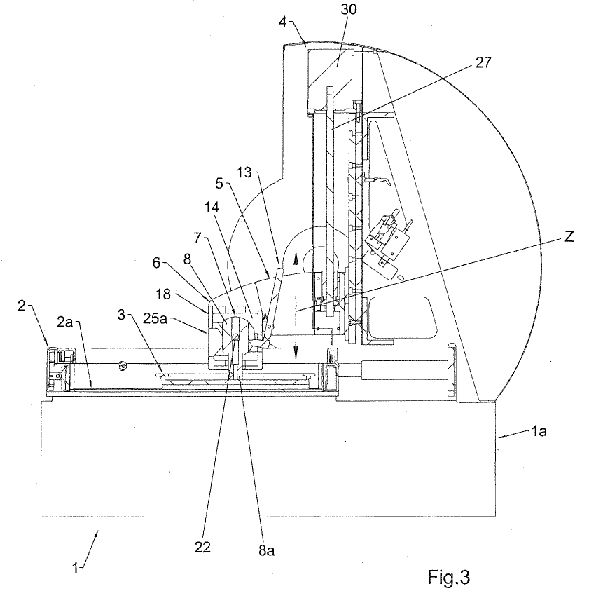

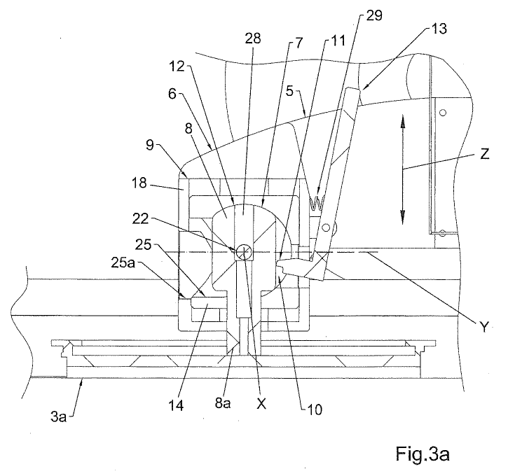

FIGS. 2 and 3 show side sectional views of the stereolithography machine of FIG. 1 in corresponding different operating configurations;

FIGS. 2a and 3a show respective enlarged details of FIGS. 2 and 3;

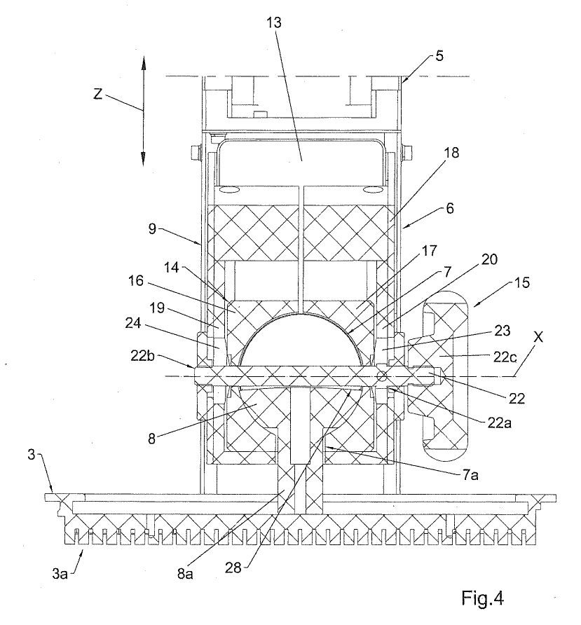

FIG. 4 shows a front sectional view of the stereolithography machine of FIG. 1;

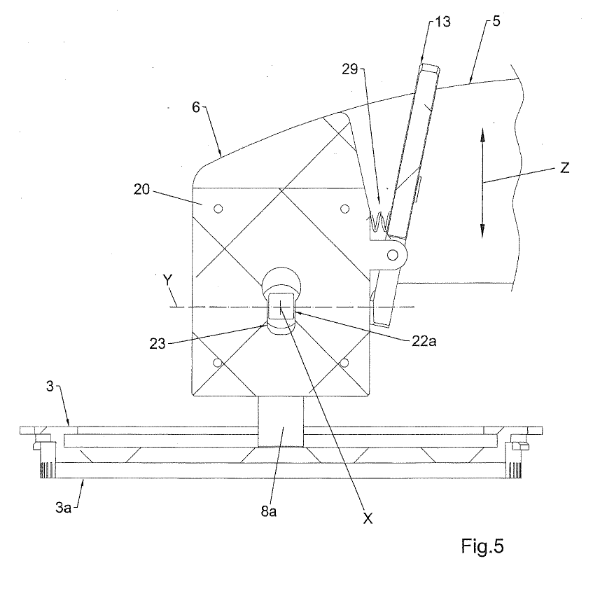

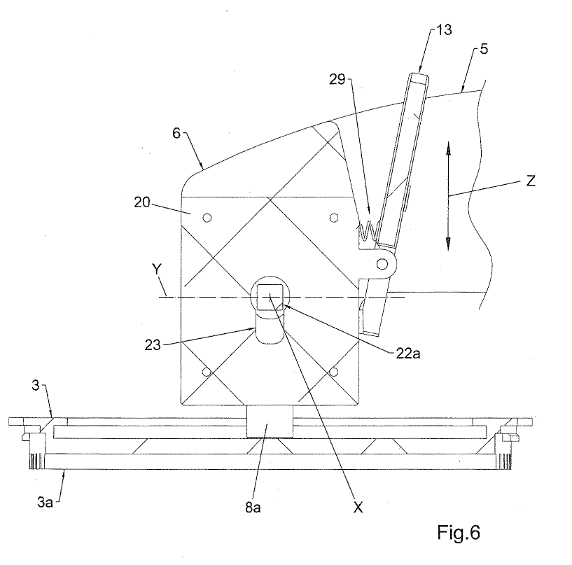

FIGS. 5 and 6 show side sectional views of a detail of the stereolithography machine of FIG. 1, respectively in the operating configurations illustrated in FIGS. 2 and 3.

The stereolithography machine of the invention, indicated as a whole by 1 in FIG. 1, comprises a frame 1a which supports a tank 2 containing a light sensitive resin and provided with a bottom 2a.

The bottom 2a is transparent, in such a way as to allow the passage of a light beam originating from a source not illustrated in the drawings but known per se, arranged under the tank 2 and suited to selectively solidify a layer of resin arranged so that it is adjacent to the bottom 2a itself.

Furthermore, a modelling plate 3 is provided, which has a modelling surface 3a facing towards the bottom 2a.

The modelling surface 3a is used to support the first layer of the three-dimensional object that is solidified, which in turn serves as a support for a second layer, and so on for the successive layers.

The modelling plate 3 is supported by a supporting unit 5, in turn associated with the frame 1a through guide means and through moving means 4 suited to move the supporting unit 5 and, consequently, the plate 3, according to a direction of movement Z orthogonal to the bottom 2a.

Preferably but not necessarily, the moving means 4 comprise a servo motor 30, for example a stepping motor, visible in FIG. 2.

Preferably, said servo motor 30 operates a worm screw 27, also visible in FIG. 2, which in turn is operatively associated with the supporting unit 5.

The moving means 4 allow the modelling plate 3 to be moved according to the direction of movement Z, in such a way as to arrange the modelling surface 3a, or the surface of the last solidified layer of the object, so that it is immersed in the resin at a distance from the bottom 2a corresponding to the thickness of the successive layer to be obtained.

In order to allow the initialization procedure described above to be carried out, the modelling plate 3 is connected to the supporting unit 5 by means of a coupling unit 6 which makes it possible to modify the position of the modelling plate 3 with respect to the supporting unit 5 and which can be locked in order to make the plate 3 integral with the supporting unit 5.

In particular, the coupling unit 6 is configured in such a way as to allow the translation of the modelling plate 3 with respect to the supporting unit 5, according to the direction of movement Z, between a first linear position, represented in FIGS. 2a and 5, in which the plate 3 is positioned further away from the supporting unit 5, and a second linear position, represented in FIGS. 3a and 6, in which it is positioned nearer to the supporting unit 5.

Preferably, the coupling unit 6 is configured so as to force the modelling plate 3 in the first linear position, for example through the presence of elastic means not illustrated in the drawings but known per se.

Advantageously, said elastic means ensure that when the supporting unit 5 is lowered, during the initialization procedure, the modelling plate 3 remains in contact with the bottom 2a of the tank 2.

In a variant embodiment of the invention, said elastic means are absent and the modelling plate 3 is forced in the first linear position by the own dead load of the plate 3 itself.

The supporting unit 5, furthermore, is configured in such a way as to allow also the rotation of the modelling plate 3 with respect to the supporting unit 5, according to a rotation axis X perpendicular to the direction of movement Z, between a first angular position, in which the modelling surface 3a is orthogonal to the direction of movement Z, and a second angular position, in which the modelling surface 3a is rotated with respect to the first angular position.

Advantageously, during the initialization procedure said rotation allows the modelling plate 3 to adapt also to possible deviations of the bottom 2a of the tank 2 around said rotation axis X with respect to the plane that is orthogonal to the direction of movement Z.

Preferably, the supporting unit 5 is configured so as to allow also a rotation of the modelling plate 3 with respect to the supporting unit 5, according to a further rotation axis Y perpendicular to the first rotation axis X and to the direction of movement Z.

Advantageously, said rotation, combined with the previous movements described above, allows the modelling plate 3 to assume a position in which it perfectly adheres to the bottom 2a of the tank 2 during the initialization procedure.

The machine furthermore comprises clamping means 9 suited to be operated in such a way as to make the modelling plate 3 and the supporting unit 5 integral with each other, so as to prevent the above mentioned translation and rotation movements, and suited to be released in such a way as to allow said movements.

According to the invention, and as can be seen in greater detail in FIGS. 2a and 3a, the coupling unit 6 comprises a housing 7 and a spherical body 8 revolvingly arranged in said housing 7 so that it can rotate around said rotation axes X and Y.

In particular, the shape of the housing 7 is such that it prevents the translation of the spherical body 8 in the three spatial directions at least when the modelling plate 3 occupies an angular position sufficiently near said first angular position, meaning when the modelling surface 3a forms, with respect to the direction of movement Z, an angle that differs from a right angle by a value smaller than a predefined value.

Preferably but not necessarily, the housing 7 has a spherical shape with diameter equal to the diameter of the spherical body 8, thus improving the stability of the coupling in any mutual angular position.

According to the invention, furthermore, the clamping means 9 are configured in such a way as to press the housing 7 and the spherical body 8 against each other, so that the consequent friction between the respective surfaces prevents any mutual movement between the two components, thus making them actually integral with each other independently of their mutual position.

It can be understood that the coupling unit 6 described above behaves as a spherical joint that allows the modelling plate 3 to rotate around the rotation axis X and, if envisaged, also around said further rotation axis Y, assuming any angular position around said axes within a predefined angular interval. Therefore, the coupling unit 6 and the clamping means 9 allow the machine to be initialized through a very simple procedure, thus achieving one of the objects of the invention.

In fact, when the clamping means 9 are in the released configuration, the spherical body 8 is free to rotate in the housing 7, thus allowing the modelling plate 3 to assume different orientations.

Therefore, the initialization procedure described above can be carried out by releasing the clamping means 9 and lowering the supporting unit 5 until arranging the modelling plate 3 so that it rests on the bottom 2a of the tank 2. Successively, the clamping means 9 are operated in such a way as to lock any mutual movement between the spherical body 8 and the housing 7, so as to fix the position of the modelling plate 3 with respect to the supporting unit 5.

The spherical constraint of the spherical body 8 is such that the operation of the clamping means 9 does not cause any relative movement between the modelling plate 3 and the supporting unit 5.

In fact, the action of the clamping means 9 is limited to the generation of sufficient friction between the housing 7 and the spherical body 8 to lock the modelling plate 3 in the position spontaneously assumed by the latter when it came into contact with the bottom 2a.

Therefore, said clamping means 9 do not cause lack of homogeneity in the contact pressures between the modelling plate 3 and the bottom 2a and, therefore, it is not necessary to complete the procedure by verifying the correct distribution of the contact pressures of the modelling plate 3.

The invention thus achieves the object to facilitate the initialization procedure of the machine 1, making the latter suited to be used even by inexpert operators.

In particular, it is not even necessary to interpose a paper sheet between the modelling plate 3 and the bottom 2a, as in the known art, and therefore any positioning error due to the uncertainty regarding the thickness of the paper sheet is avoided, thus achieving the further object to obtain an extremely precise initialization procedure.

Consequently, the processing of the three-dimensional object can be performed with no need to create “disposable” additional layers.

Therefore, it is advantageously possible to reduce the time required to process the object and the consumption of resin.

Still advantageously, the absence of additional layers eliminates the need to remove them through a successive finishing operation, thus further increasing the ease of use of the machine 1.

The fact that it is not necessary to use a paper sheet to control the distribution of pressure implies the further advantage that the initialization procedure can be carried out even if there is resin in the tank 2, with no need to empty it. Furthermore, once the modelling plate 3 has been brought into contact with the bottom 2a and has been fixed to the supporting unit 5, the position obtained in this way can be directly used by the control system of the supporting unit 5 as a reference position for the processing cycle. Therefore, it is possible to start the processing cycle with no need to carry out any further setting up operation on the machine, thus further increasing ease of use and reducing the processing time.

Preferably, and as shown in particular in FIG. 4, the spherical body 8 is integral with the modelling plate 3, to which it is connected through a connection body 8a, while the housing 7 is connected to the supporting unit 5 and defines a slot 7a which houses the connection body 8a and allows it to move during the rotary movements of the spherical body 8 in the housing 7 according to the two rotation axes X and Y.

In particular, the slot 7a extends around the rotation axis X over an angle equal to that which separates the first angular position from the second angular position.

Furthermore, the width of the slot 7a in the direction perpendicular to said angular extension exceeds the width of the connection body 8a, in such a way as to allow a certain rotation of the spherical body 8 according to the rotation axis Y.

It is evident that, in variant embodiments of the invention not illustrated in the drawings, the housing 7 can be connected to the modelling plate 3 and the spherical body 8 can be integral with the supporting unit 5, without for this reason modifying the substance of the invention.

The solution described can be adapted, with the necessary and obvious modifications, also to the variant embodiments just mentioned above.

Preferably, and as shown in FIG. 2a, the coupling unit 6 comprises also releasable stop means 10 suited to be operated to lock the modelling plate 3 in said second angular position.

In this way, at the end of the processing of the three-dimensional object, the modelling plate 3 can be locked in the second angular position with the modelling surface 3a inclined, so that the excess liquid resin can easily drip into the underlying tank 2, thus further increasing the ease of use of the machine.

Preferably, the second angular position is separated from the first angular position by approximately 90°, in such a way as to determine a vertical position of the modelling surface 3a, thus ensuring better dripping of the excess resin. Preferably, the stop means 10 comprise a stop body 11 which is maintained in contact with the spherical body 8 through the action of elastic means 29 visible in detail in FIG. 2a.

Furthermore, the spherical body 8 is provided with a recess 12 suited to house the stop body 11 which snaps into it when the modelling plate 3 is arranged in the second angular position, release means 13 being provided, which can be operated by the user in order to release the stop body 11 from the recess 12. In this way, when the modelling plate 3 is rotated in the second angular position, the stop body 11 automatically snaps into the recess 12, in such a way as to hold the spherical body 8 and, consequently, the modelling plate 3 in the second angular position.

Preferably, the release means 13 comprise a lever which can be accessed by the user and which, when shifted, causes the stop body 11 to be extracted from the recess 12 and, consequently, the modelling plate 3 to be released, thus allowing the latter to be rotated in an angular position different from the first angular position.

Said rotation of the modelling plate 3 can be performed manually or, more preferably, can take place spontaneously, which can be obtained, for example, by configuring the modelling plate 3 itself in such a way that its centre of gravity is shifted horizontally with respect to the rotation centre defined by the spherical body 8.

This makes it possible to exploit the weight of the plate 3 in order to induce a torque which tends to rotate the plate 3 itself towards the first angular position. Still preferably, the coupling unit 6 includes friction means intended to brake the lowering movement of the modelling plate 3 towards the first angular position, which may include the presence of a slight interference between the spherical body 8 and its housing 7, or between the connection body 8a and the slot 7a.

It is evident that, in variant embodiments of the invention, the stop means 10 can assume configurations different from the one described above.

For example, according to a possible variant embodiment of the stop means 10, not illustrated in the drawings, the stop body 11 is provided with a recess and the spherical body 8 is provided with a corresponding projecting body suited to be fitted in said recess.

Preferably, the machine 1 is also equipped with a sensor, not illustrated in the figures but known per se, configured to detect the angular position of the modelling plate 3.

The machine 1 is furthermore equipped with a system which prevents the start of the processing cycle if said sensor signals that the modelling plate 3 is in the second angular position.

As regards the clamping means 9, these preferably comprise a hollow body 14 that defines the housing 7.

The hollow body 14 can be deformed in such a way as to be pressed around the spherical body 8 and is associated with control means 15 suited to be operated to cause said deformation.

Preferably, the deformability of the hollow body 14 is obtained by making the latter so that it is constituted by two half-bodies 16, 17 mutually facing each other and removably associated with each other, visible in detail in the sectional view of FIG. 4, while the control means 15 can be operated in order to vary the mutual distance between the half-bodies 16, 17.

Preferably, the half-bodies 16, 17 are mutually symmetrical and each one of them defines a corresponding cavity in a substantially hemispherical shape. Still preferably, the half-bodies 16, 17 are connected to the supporting unit 5 through elastic means that keep them in contact with the spherical body 8, in such a way as to prevent the latter from translating with respect to the housing 7, though allowing it to rotate.

Still preferably, the hollow body 14 is slidingly associated with the supporting unit 5 according to the direction of movement Z through a guide body 18 which, preferably, prevents the rotations of the hollow body 14 as well as its translations according to directions that are orthogonal to the direction of movement Z.

During the initialization procedure, said guide body 18 allows the modelling plate 3 to translate with respect to the supporting unit 5, in such a way as to ensure that the modelling surface 3a comes into contact with the bottom 2a of the tank 2.

In fact, said translation movement makes it possible to extend the lowering movement of the modelling plate 3 beyond the moment of the actual contact of the modelling surface 3a with the bottom 2a, giving the plate 3 time to correctly rest on the bottom 2a.

For this purpose, forcing means are provided which force the modelling plate 3 towards the first linear position and which, advantageously, ensure perfect contact between the plate 3 and the bottom 2a during said lowering movement. Preferably, said forcing means comprise elastic means interposed between the hollow body 14 and the guide body 18, not illustrated in the figures but known per se.

According to a variant embodiment, said forcing means comprise the dead load of the modelling plate 3, which tends to push the latter downwards, overcoming any possible friction.

Preferably, the hollow body 14 is contained inside the guide body 18 mentioned above and the latter can be deformed in such a way as to press the hollow body 14 around the spherical body 8, in such a way as to lock the modelling plate 3 as described above.

It can be understood that the configuration just described above allows, with a single deformation of the guide body 18, to prevent both the translation of the hollow body 14 in the direction of movement Z and the rotation of the spherical body 8 in the housing 7, thus facilitating the initialization of the machine.

The condition just described above is preferably obtained by equipping the guide body 18 with two jaws 19, 20 which face the hollow body 14 on respective opposite sides.

The jaws 19, 20 are removably associated with each other through the control means 15 mentioned above, which can be operated to adjust the mutual distance between the jaws themselves.

Preferably, said control means 15 comprise a screw 22, preferably provided with an operating knob 22c.

Said screw 22 connects the two jaws 19, 20 with each other, in such a way that the rotation of the screw 22 in one direction causes the jaws 19, 20 to move near each other and, therefore, the latter to be pressed around the hollow body 14, and the rotation of the screw 22 in the opposite direction allows the two jaws 19, 20 to be loosened and the hollow body 14 to be consequently released.

Preferably, the machine 1 is provided with a locking device suited to prevent the operation of the screw 22 when the modelling plate 3 is arranged in the first linear position.

Advantageously, said locking means prevent the modelling plate 3 from being locked on the supporting unit 5 when it is still lifted from the bottom 2a of the tank 2 and, therefore, before the initialization procedure has been completed. In this way, it is possible to avoid damaging the bottom 2a of the tank 2 during the lowering movement of the modelling plate 3.

Preferably, the locking device comprises means suited to constrain the screw 22 to the spherical body 8 according to the direction of movement Z in such a way that, when the spherical body 8 moves with respect to the supporting unit 5 following the movement of the modelling plate 3 from the first linear position towards the second linear position, the screw 22 is moved accordingly.

The locking device furthermore comprises, in each one of the jaws 19, 20, a corresponding through slot 23, 24 having an elongated shape that follows the direction of movement Z, which houses a corresponding end 22a, 22b of the screw 22 and allows it to slide according to the direction of movement Z.

At least one first end 22a of the screw 22 and the corresponding first through slot 23 in which said first end 22a is inserted are configured so as to prevent the rotation of the screw 22 when the first end 22a is arranged in a first position along the first through slot 23, corresponding to the condition in which the modelling plate 3 is in its first linear position, illustrated in FIG. 5.

At the same time, the first end 22a and the first through slot 23 are configured so as to allow the rotation of the screw 22 when the first end 22a is arranged in a second position along the first through slot 23, corresponding to the condition in which the modelling plate 3 is in the second linear position, illustrated in FIG. 6.

As long as the modelling plate 3 is lifted from the bottom 2a, as shown in FIG. 2, and is thus in the first position, the first end 22a is locked in the first through slot 23, as shown in FIG. 2a, making it impossible to use the screw 22 to lock the modelling plate 3 to the supporting unit 5.

Vice versa, when the modelling plate 3 is in contact with the bottom 2a, in the second position shown in FIG. 3, the screw 22 moves upwards along the slot 23 in such a way that its first end 22a is free to rotate, as can be seen in FIG. 3a, so as to allow the user to lock the modelling plate 3.

As can be seen in FIGS. 5 and 6, the conditions described above are preferably obtained by providing the first end 22a of the screw 22 with a square-shaped cross section, while the first through slot 23 is configured in such a way that it has two sections with different width.

More precisely, the lower end of the first through slot 23, corresponding to the area occupied by the screw in said first position, is larger than the side of said square-shaped cross section and smaller than its diagonal, while the upper end is larger than said diagonal.

It is evident, on the other hand, that said conditions can be obtained by configuring the first end 22a and the first through slot 23 in a different way than that just described above, provided that, according to a first direction, the cross section of the first end 22a is narrower than its maximum width according to a direction incident on said first direction and that, furthermore, the width of the section of the first through slot 23 occupied by the screw 22 in said first position is included between said two widths and the width of the section of the first through slot 23 occupied by the screw 22 in said second position exceeds said maximum width.

In order to constrain the screw 22 to the spherical body 8 as described above, the latter is preferably provided with a through opening 28 which houses the screw 22.

According to a variant embodiment of the invention, not illustrated in the drawings, the screw 22 is associated with the housing 7 in such a way as to obtain a constraint that is analogous to that described above.

Preferably, and as can be seen for example in FIG. 2a, the cross section of the spherical body 8 according to a reference plane passing through the rotation axis X has a flattened shape.

At the same time, the hollow body 14 and the guide body 18 are provided with respective openings 25, 25a whose shape matches said flattened cross section of the spherical body 8.

In particular, said openings 25 and 25a are configured so as to make it impossible to extract the spherical body 8 from the hollow body 14 and from the guide body 18 when the modelling plate 3 is arranged in the first angular position and to allow it to be extracted when the modelling plate 3 is arranged in the second angular position, or in any case in a position different from the first angular position.

Said flattened cross section of the spherical body 8 and the presence of the openings 25 and 25a make it possible to uncouple the spherical body 8 from the housing 7 in a simple and rapid manner when the modelling plate 3 is in the second angular position, for example in order to remove the object from the machine at the end of the processing cycle with no need to detach it from the modelling plate 3.

This, advantageously, makes it easier for the user to clean and finish the object, as well as to separate the latter from the plate.

Preferably, said flattened cross section has two rectilinear portions opposing each other with respect to the screw 22 and corresponding to two respective plane and parallel surfaces of the spherical body 8.

It is also evident that, in variant embodiments of the invention not illustrated herein, the flattened cross section can even have just one of said rectilinear portions, or one or more portions in a shape different from the circular shape. As regards the through opening 28 of the spherical body 8 which houses the screw 22 described above, it preferably extends according to a reference direction that is orthogonal to the screw 22 until reaching the surface of the spherical body 8, in such a way as to have an open side.

In particular, the reference direction coincides with the direction of extraction of the spherical body 8 from the housing 7 when the modelling plate 3 is arranged in the second angular position.

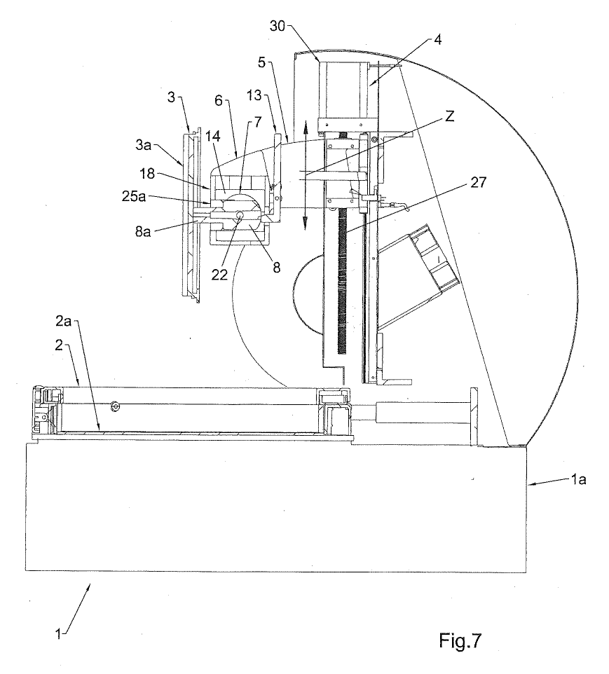

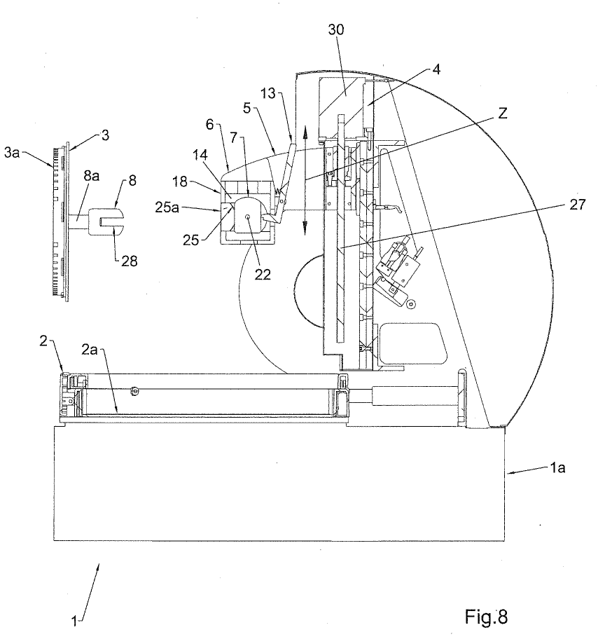

The through opening 28 with the configuration just described above makes it possible to extract the spherical body 8 from the housing 7 and to introduce it in the latter with no need to remove the screw 22, in the manner illustrated by the succession of FIGS. 7 and 8.

As a result of the above, the screw 22 is arranged so that it is parallel to the rotation axis X, in such a way as to hinder neither the rotation of the spherical body 8, nor its extraction from the housing 7.

Operatively, the initialization procedure of the stereolithography machine 1 described above is carried out by arranging the modelling plate 3 as shown in FIG. 8 and introducing the spherical body 8 in the housing 7 as shown in FIG. 7.

Successively, the modelling plate 3 can be rotated until it reaches the first angular position shown in FIG. 2.

In the configuration just described above, the clamping means 9 are maintained in the released position.

Successively, the operator activates the supporting unit 5 in such a way as to place the modelling plate 3 in contact with the bottom 2a of the tank 2, as can be seen in FIG. 3.

The mobility of the spherical body 8 with respect to the housing 7 allows the modelling plate 3 to adapt its orientation to that of the bottom 2a.

Preferably, in order to ensure full contact of the plate 3 with the bottom 2a, the supporting unit 5 is lowered further, causing the spherical body 8 and the screw 22 to be shifted with respect to the supporting unit 5 and, therefore, with respect to the guide body 18 and to the respective slots 23, 24.

Said lowering movement of the supporting unit 5 proceeds until the first end 22a of the screw 22 is released from the first slot 23 so as to allow the activation of the screw 22 itself.

Preferably, the process described above takes place automatically, through an initialization cycle according to which the supporting unit 5 is first lifted until reaching a reference position detected by an apposite sensor and successively the supporting unit 5 is lowered by a predefined distance suited to ensure that said release takes place, taking into account the geometric tolerance of the bottom 2a of the tank 2.

At this point, the operator can activate the clamping means 9 in order to fix the modelling plate 3 to the supporting unit 5, so as to complete the initialization procedure.

The position of the supporting unit 5 at the end of the initialization procedure is stored by the control system of the machine 1 as the reference position for the processing cycle, which can start immediately with no need for further adjustments by the user.

From the explanation provided above it can be understood that the stereolithography machine described above achieves all the objects of the invention.

In particular, the coupling unit and the clamping means of the machine that is the subject of the invention make it possible to fix the modelling plate to the supporting unit independently of its position and with no need to modify said position.

This eliminates the complex series of adjusting operations that need to be performed on the modelling plate for the initialization of the machines of the known type and, furthermore, allows a very precise initialization procedure to be performed, since it is not necessary to interpose any spacer between the plate and the bottom of the tank, which would cause a tolerance to be introduced with regard to the positioning of the plate itself.

1-11. (canceled)

12. Stereolithography machine comprising:
a tank suited to contain a light sensitive resin and provided with a bottom;
a supporting unit associated with moving means suited to move said supporting unit according to a direction of movement which is orthogonal to said bottom;
a modelling plate provided with a modelling surface which faces said bottom in order to support a three-dimensional object;
a coupling unit suited to connect said modelling plate to said supporting unit, configured to allow said modelling plate to translate with respect to said supporting unit, according to said direction of movement, between a first linear position, in which said modeling plate is further away from said supporting unit, and a second linear position, in which said modeling plate is nearer to said supporting unit, and to allow said modelling plate to rotate with respect to said supporting unit, according to at least one rotation axis which is perpendicular to said direction of movement, between a first angular position, in which said modelling surface is orthogonal to said direction of movement, and a second angular position, in which said modelling surface is rotated with respect to said first angular position, said coupling unit comprising a housing and a spherical body revolvingly arranged in said housing so that said spherical body can rotate at least according to said rotation axis;
releasable clamping means;
characterized in that said clamping means comprises:
a hollow body which defines said housing, said hollow body being deformable so that it can be pressed around said spherical body;
control means suited to be operated to press said hollow body around said spherical body in such a way as to make said modelling plate and said supporting unit integral with each other in such a way as to prevent said translation and said rotation.

13. Stereolithography machine according to claim 12, characterized in that said coupling unit comprises releasable stop means suited to be operated to lock said modelling plate in said second angular position.

14. Stereolithography machine according to claim 13, characterized in that said stop means comprise a stop body maintained in contact with said spherical body through the action of elastic means, said spherical body being provided with a recess suited to house said stop body which snaps into it when said modelling plate is arranged in said second angular position, release means being provided which are suited to be operated to release said stop body from said recess.

15. Stereolithography machine according to claim 12, characterized in that said hollow body comprises two half-bodies mutually facing each other and removably associated with each other, said control means being suited to be operated to vary the mutual distance between said half-bodies.

16. Stereolithography machine according to claim 12, characterized in that said hollow body is slidingly associated with said supporting unit according to said direction of movement through a guide body.

17. Machine according to claim 16, characterized in that it comprises forcing means suited to force said modelling plate in said first linear position.

18. Machine according to claim 16, characterized in that said guide body comprises two jaws between which said hollow body is interposed, said control means being configured so as to press said two jaws against said hollow body.

19. Machine according to claim 18, characterized in that said control means comprise a screw which connects said two jaws with each other in such a way that the rotation of said screw in a first direction causes said jaws to mutually approach each other.

20. Machine according to claim 19, characterized in that said screw is constrained to said spherical body and/or to said housing according to at least one sense of said direction of movement, and in that each one of said jaws is provided with a corresponding through slot having an elongated shape that follows said direction of movement and slidingly housing a corresponding end of said screw according to said direction of movement, a first end of said screw and the corresponding first through slot being configured to prevent the rotation of said screw when said first end is arranged in a first position along said first through slot, corresponding to the condition in which said modelling plate is in said first linear position, and to allow said rotation when said first end is arranged in a second position along said first through slot, corresponding to the condition in which said modelling plate is in said second linear position.

21. Stereolithography machine according to claim 16, characterized in that the cross section of said spherical body according to a reference plane passing through said rotation axis has a flattened shape, said hollow body and/or said guide body being provided with an opening whose shape matches said flattened cross section, configured so as to prevent the extraction of said spherical body from said hollow body and/or from said guide body when said modelling plate is arranged in said first angular position and to allow said extraction when said modelling plate is arranged in a position different from said first angular position and preferably coinciding with said second angular position.

22. Stereolithography machine according to claim 13, characterized in that said hollow body comprises two half-bodies mutually facing each other and removably associated with each other, said control means being suited to be operated to vary the mutual distance between said half-bodies.

23. Stereolithography machine according to claim 14, characterized in that said hollow body comprises two half-bodies mutually facing each other and removably associated with each other, said control means being suited to be operated to vary the mutual distance between said half-bodies.

24. Stereolithography machine according to claim 13, characterized in that said hollow body is slidingly associated with said supporting unit according to said direction of movement through a guide body.

25. Stereolithography machine according to claim 14, characterized in that said hollow body is slidingly associated with said supporting unit according to said direction of movement through a guide body.

26. Stereolithography machine according to claim 15, characterized in that said hollow body is slidingly associated with said supporting unit according to said direction of movement through a guide body.

27. Machine according to claim 17, characterized in that said guide body comprises two jaws between which said hollow body is interposed, said control means being configured so as to press said two jaws against said hollow body.

28. Stereolithography machine according to claim 17, characterized in that the cross section of said spherical body according to a reference plane passing through said rotation axis has a flattened shape, said hollow body and/or said guide body being provided with an opening whose shape matches said flattened cross section, configured so as to prevent the extraction of said spherical body from said hollow body and/or from said guide body when said modelling plate is arranged in said first angular position and to allow said extraction when said modelling plate is arranged in a position different from said first angular position and preferably coinciding with said second angular position.

29. Stereolithography machine according to claim 18, characterized in that the cross section of said spherical body according to a reference plane passing through said rotation axis has a flattened shape, said hollow body and/or said guide body being provided with an opening whose shape matches said flattened cross section, configured so as to prevent the extraction of said spherical body from said hollow body and/or from said guide body when said modelling plate is arranged in said first angular position and to allow said extraction when said modelling plate is arranged in a position different from said first angular position and preferably coinciding with said second angular position.

30. Stereolithography machine according to claim 19, characterized in that the cross section of said spherical body according to a reference plane passing through said rotation axis has a flattened shape, said hollow body and/or said guide body being provided with an opening whose shape matches said flattened cross section, configured so as to prevent the extraction of said spherical body from said hollow body and/or from said guide body when said modelling plate is arranged in said first angular position and to allow said extraction when said modelling plate is arranged in a position different from said first angular position and preferably coinciding with said second angular position.

31. Stereolithography machine according to claim 20, characterized in that the cross section of said spherical body according to a reference plane passing through said rotation axis has a flattened shape, said hollow body and/or said guide body being provided with an opening whose shape matches said flattened cross section, configured so as to prevent the extraction of said spherical body from said hollow body and/or from said guide body when said modelling plate is arranged in said first angular position and to allow said extraction when said modelling plate is arranged in a position different from said first angular position and preferably coinciding with said second angular position.
